(19) United States
(12) Patent Application Publication
(10) Pub. No.: US 2013/0287933 A1
(43) Pub. Date: Oct. 31, 2013

(54) THREE-DIMENSIONAL (3D) PRINTING

(71) Applicants: Pierre J. KAISER, Portland, OR (US); David M. Wetchler, Vancouver, WA (US)

(72) Inventors: Pierre J. KAISER, Portland, OR (US); David M. Wetchler, Vancouver, WA (US)

(21) Appl. No.: 13/455,320

(22) Filed: Apr. 25, 2012

(51) Int. Cl. B05D 1/36; B05C 5/02

(52) U.S. Cl. 427/9; 118/696; 427/265

(57) ABSTRACT

In at least some examples, a three-dimensional (3D) printing system comprises a coarse 3D printing interface to form a 3D object core. The 3D printing system also comprises a fine 3D printing interface to form a 3D object shell around at least some of the 3D object core. The 3D printing system also comprises a controller to receive a dataset corresponding to a 3D object model and to direct the coarse 3D printing interface to form the 3D object core based on the dataset.

### BACKGROUND

Three-dimensional (3D) printing refers to processes that create 3D objects based on digital 3D object models and a materials dispenser. In 3D printing, a dispenser moves in at least 2-dimensions and dispenses material accordance to a determined print pattern. To a build a 3D object, a platform that holds the object being printed is adjusted such that the dispenser is able to apply many layers of material. In other words, a 3D object may be printed by printing many layers of material, one layer at a time. If the dispenser moves in 3-dimensions, movement of the platform is not needed. 3D printing features such as speed, accuracy, color options, and cost, vary for different dispensing mechanisms and materials.

### BRIEF DESCRIPTION OF THE DRAWINGS

For a detailed description of illustrative examples of the disclosure, reference will now be made to the accompanying drawings in which:

FIG. 1 shows an example of a hybrid three-dimensional (3D) printer in accordance with the disclosure;

FIGS. 2A and 2B show examples of hybrid 3D printing systems in accordance with the disclosure;

FIG. 3 shows another example of a hybrid 3D printer in accordance with the disclosure;

FIG. 4 shows another example of a hybrid 3D printer in accordance with the disclosure;

FIG. 5 shows another example of a hybrid 3D printing system in accordance with the disclosure;

FIG. 6 shows an example of a computer system in accordance with the disclosure; and

FIG. 7 shows an example of a hybrid 3D printing method in accordance with the disclosure.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, or through a wireless electrical connection.

### DETAILED DESCRIPTION

The following discussion is directed to hybrid three-dimensional (3D) printing techniques and systems. While various examples of hybrid 3D printing are provided, the examples disclosed should not be interpreted, or otherwise used, as limiting the scope of the disclosure, including the claims. In addition, one skilled in the art will understand that the following description has broad application, and the discussion of any particular example is not intended to intimate that the scope of the disclosure, including the claims, is limited to that example.

As disclosed herein, “hybrid” 3D printing refers to combining two different 3D printing technologies to build a single 3D object. For example, a course 3D printing interface may be employed to form a 3D object core while a fine 3D printing interface is employed to form a 3D object shell around at least some of the 3D object core. In this manner, a 3D object core is built up efficiently and inexpensively, while the 3D object shell provides an improved finish (e.g., smoothness and coloring) for the 3D object compared to the 3D object core. As a specific example, fused deposition modeling (FDM) may be employed to form a 3D object core while thermal inkjet 3D printing is employed to form a 3D object shell around at least some of the FDM-based 3D object core. Other examples of coarse 3D printing for 3D object cores and fine 3D printing for 3D object shells will be appreciated by those in the relevant art.

There are several different 3D printing technologies that could be combined for hybrid 3D printing as disclosed herein. For example, a hybrid 3D printer could use selective laser sintering (SLS) or fused deposition modeling (FDM), which melt or soften materials to build 3D objects. Further, a hybrid 3D printer could use stereolithography (SLA), which applies layers of curable (e.g., by heat or ultraviolet (UV) light) materials to build 3D objects. Further, a hybrid 3D printer could use a 3D printing technology that solidifies layers of deposited powder using a liquid binder. Further, a hybrid 3D printer could use inkjet printing technology to dispense a liquid binder or a curable material.

The different 3D printing technologies available vary with regard to cost, speed, precision, material coloring, and material strength. For example, FDM can quickly and cheaply generate durable object shapes compared other 3D printing technologies. However, coloring and smoothness of 3D objects are more limited using FDM compared to other 3D printing technologies.

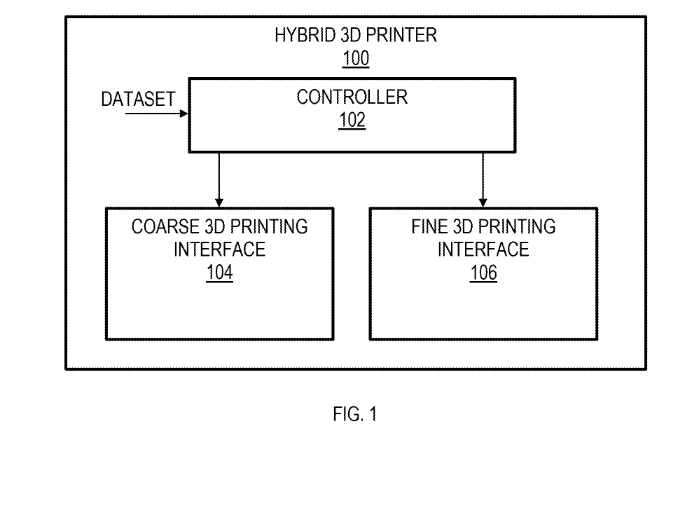

FIG. 1 shows an example of a hybrid three-dimensional (3D) printer 100 in accordance with the disclosure. As shown, the hybrid 3D printer 100 comprises a controller 102 in communication with a coarse 3D printing interface 104 and with a fine 3D printing interface 106. The controller 102 directs the coarse 3D printing interface 104 and/or the fine 3D printing interface 106 based on a dataset corresponding to a digital 3D object model. More specifically, the controller 102 directs the coarse 3D printing interface 104 to form an object core based on the dataset and directs the fine 3D printing interface 106 to form an object shell around at least some of the 3D object core.

In the example of FIG. 1, the coarse 3D printing interface 104 may comprise an FDM dispenser (e.g., a nozzle through which heated or melted material is dispensed), or other coarse material dispenser, to form 3D object cores. Meanwhile, the fine 3D printing interface 106 comprises a thermal ink jet (TIJ) dispenser (e.g., an inkjet printhead), or other fine material dispenser, to provide an improved finish around at least some the 3D object sore by forming a 3D object shell. The 3D object shell may be applied to once the 3D object core is finished in its entirety. Alternatively, part of a 3D object shell may be applied to a layer of 3D object core even though the 3D object core is unfinished. The decision to apply the 3D object shell to an unfinished 3D object core may be made, for example, based on the shape of the 3D object. In other words, if the shape of the completed 3D object core prevents or makes difficult the application of the 3D object shell, then the 3D object shell may be applied to certain parts of the 3D object core while it is still unfinished. After a 3D object shell has been applied to selected portions of the unfinished 3D object core, the controller 102 directs to the coarse 3D printing interface 104 to continue the process of forming the 3D object core. The process of switching between coarse 3D printing and fine 3D printing may continue as needed until the 3D object corresponding to the digital 3D object model in the dataset is completed.

In some examples, a coarse material dispenser and a fine material dispenser are mounted to a single gantry in communication with the controller 102. As used herein, a “gantry” refers to a motorized support or framework for at least one dispenser. The coarse material dispenser and the fine material dispenser may be offset from each other and fixed in place. Alternatively, the coarse material dispenser and the fine material dispenser may be part of a rotating component mounted to the gantry. In other examples, the course material dispenser and the fine material dispenser are mounted to separate gantries in communication with the controller 102.

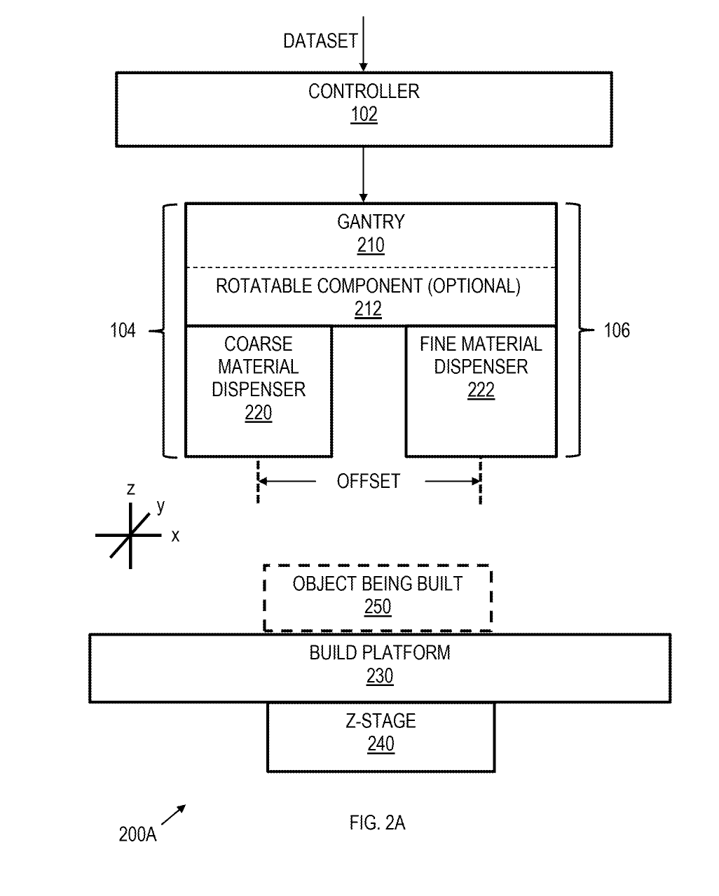

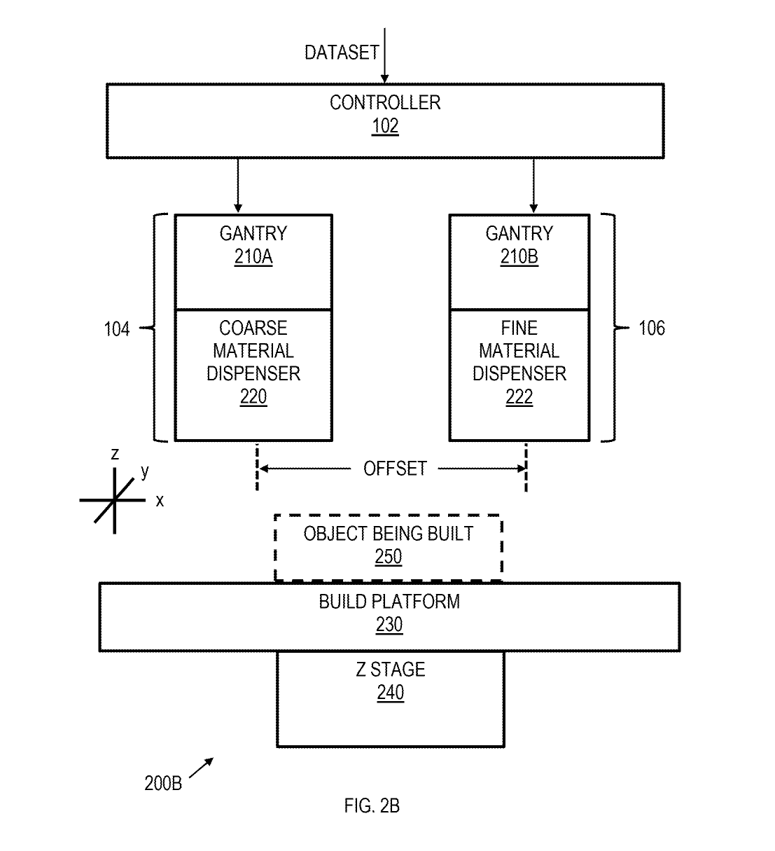

FIGS. 2A and 2B show examples of hybrid 3D printing systems in accordance with the disclosure. In FIG. 2A, the hybrid 3D printing system 200A comprises a controller 102 as described for FIG. 1. The controller 102 is in communication with and directs a single gantry 210 to move a coarse material dispenser 220 and/or a fine material dispenser 222 mounted to the gantry 210. Thus, for the hybrid 3D printing system 200A, the gantry 210 is a component of both a coarse 3D printing interface 104 and a fine 3D printing interface 106 as described for FIG. 1. More specifically, the gantry 210 and the coarse material dispenser 220 are components of a coarse 3D printing interface 104 as described for FIG. 1. Meanwhile, the gantry 210 and the fine material dispenser 222 are components of a fine 3D printing interface 106 as described for FIG. 1.

In some examples, the gantry 210 operates to move the coarse material dispenser 220 in the x-y plane (i.e., two-dimensional movement) while dispensing of coarse material occurs to form a 3D object core. Further, the gantry 210 operates may move the fine material dispenser 222 in the x-y plane while dispensing of fine materials occurs to form a 3D object shell. In either case, a z-stage 240 upon which a build platform 230 is mounted may move along the z axis while material is being dispensed by the coarse material dispenser 220 or the fine material dispenser 222. In other examples, the gantry 210 operates to move the coarse material dispenser 220 in the x-y-z planes (i.e., three-dimensional movement) while dispensing of coarse material occurs to form a 3D object shell. Similarly, the gantry 210 may operate to move the fine material dispenser 222 in the x-y-z planes while dispensing of fine material occurs to form a 3D object shell. If the gantry 210 supports movement in the x-y-z planes, the z-stage 240 can be omitted or may optionally move along the z axis to form a 3D object core or a 3D object shell of an object being built 250. In some examples, the range of the gantry 210 and the z-stage 240 along the z axis may vary and/or may be combined to form a 3D object core or a 3D object shell of an object being built 250. In addition to movement by the gantry 210 and the z-stage 240, the angle at which the coarse material dispenser 220 and/or the fine material dispenser 222 dispense material may be adjusted to facilitate forming the 3D object core or the 3D object shell.

In the hybrid 3D printing system 200A, the z-stage 240 and the build platform 230 may be part of a hybrid 3D printing unit having the controller 102, the coarse 3D printing interface 104, and the fine 3D printing interface 106 shown for FIG. 2A. Alternatively, the z-stage 240 and the build platform 230 may be separate from a hybrid 3D printing unit having the controller 102, the coarse 3D printing interface 104, and the fine 3D printing interface 106 shown for FIG. 2A.

In some examples of the hybrid 3D printing system 200A, the coarse material dispenser 220 and the fine material dispenser 222 are offset from each other and/or the positioning system for the gantry 210. The offset may be known or is determinable using an offset calibration technique and is accounted for when forming a 3D object core and/or a 3D object shell as described herein. In some examples, the coarse material dispenser 220 is centered with the positioning system of the gantry 210 while the fine material dispenser 222 is offset by a predetermined amount. In other examples, the fine material dispenser 222 is centered with the positioning system of the gantry 210 while the coarse material dispenser 220 is offset by a predetermined amount. In other examples, both the fine material dispenser 222 and the coarse material dispenser 220 are offset from the positioning system of the gantry 210. Regardless of the offset location or amount, the controller 102 is able to determine the offset and adjust the operation of a coarse 3D printing interface 104 to form a 3D object core and/or a fine 3D printing interface 106 to form a 3D object shell. As shown, the coarse material dispenser 220 and the fine material dispenser 222 may be optional mounted to a rotatable component 212. The rotatable component 212 enables each of the coarse material dispenser 220 and the fine material dispenser 222 to be rotated between an active position and an inactive position. For example, the active position for each of the coarse material dispenser 220 and the fine material dispenser 222 may be centered with the positioning system of the gantry 210. Alternatively, one or both of the coarse material dispenser 220 and the fine material dispenser 222 may be offset in relation to the positioning system of the gantry 210. In either case, the rotatable component 212 may reduce the likelihood of interference between an inactive dispenser and a 3D object being built 250 (i.e., a 3D object core or a 3D object shell) by an active dispenser.

In FIG. 2B, the hybrid 3D printing system 200B comprises a controller 102 as described for FIG. 1. The controller 102 is in communication with and directs separate gantries 210A and 210B that respectively hold up a coarse material dispenser 220 and a fine material dispenser 222. Thus, for the hybrid 3D printing system 200B, the gantry 210A is a component of a coarse 3D printing interface 104 as described for FIG. 1 while the gantry 210B is a component of a fine 3D printing interface 106 as described for FIG. 1. More specifically, the gantry 210A and the coarse material dispenser 220 are components of a coarse 3D printing interface 104 as described for FIG. 1. Meanwhile, the gantry 210B and the fine material dispenser 222 are components of the fine 3D printing interface 106 as described for FIG. 1.

In some examples, the gantry 210A operates to move the coarse material dispenser 220 in the x-y plane (i.e., two-dimensional movement) while dispensing of coarse material occurs to form a 3D object core. Further, the gantry 210B operates to move the fine material dispenser 222 in the x-y plane while dispensing of fine materials occurs to form a 3D object shell. In either case, a z-stage 240 upon which a build platform 230 is mounted moves along the z axis while material is being dispensed by the coarse material dispenser 220 or the fine material dispenser 222. In other examples, the gantry 210A operates to move the coarse material dispenser 220 in the x-y-z planes (i.e., three-dimensional movement) while dispensing of coarse material occurs to form a 3D object shell. Similarly, the gantry 210B may operate to move the fine material dispenser 222 in the x-y-z planes while dispensing of fine material occurs to form a 3D object shell. If the gantries 210A and 210B support movement in the x-y-z planes, the z-stage 240 can be omitted or may optionally move along the z axis to form a 3D object core or a 3D object shell of an object being built 250. In some examples, the range of the gantries 210A and 210B and of the z-stage 240 along the z axis may vary and/or may be combined to form a 3D object core or a 3D object shell of an object being built 250. In addition to movement by the gantries 210A and 210B, and the z-stage 240, the angle at which the coarse material dispenser 220 and/or the fine material dispenser 222 dispense material may be adjusted to facilitate forming the 3D object core or the 3D object shell.

In the hybrid 3D printing system 200B, the z-stage 240 and the build platform 230 may be part of a hybrid 3D printing unit having the controller 102, the coarse 3D printing interface 104, and the fine 3D printing interface 106 shown for FIG. 2B. Alternatively, the z-stage 240 and the build platform 230 may be separate from a hybrid 3D printing unit having the controller 102, the coarse 3D printing interface 104, and the fine 3D printing interface 106 shown for FIG. 2B.

In some examples of the hybrid 3D printing system 200B, the coarse material dispenser 220 and the fine material dispenser 222 are offset from each other and/or the positioning system(s) for the gantries 210A and 210B. The offset may be known or is determinable using an offset calibration technique and is accounted for when forming a 3D object core and/or a 3D object shell as described herein. In some examples, the coarse material dispenser 220 is centered with the positioning system of the gantries 210A and 210B while the fine material dispenser 222 is offset by a predetermined amount. In other examples, the fine material dispenser 222 is centered with the positioning system of the gantries 210A and 210B while the coarse material dispenser 220 is offset by a predetermined amount. In other examples, both the fine material dispenser 222 and the coarse material dispenser 220 are offset from the positioning system of the gantries 210A and 210B. To account for any offsets, the controller 102 adds or calculates the offset in relation to the positioning system for each of the gantries 210A and 210B. With the separate gantries 210A and 210B, the coarse material dispenser 220 and the fine material dispenser 222 may respectively switch between an active position and an inactive position. For example, the active position for each of the coarse material dispenser 220 and the fine material dispenser 222 may be centered with the positioning system of the gantries 210A and 210B. Alternatively, one or both of the coarse material dispenser 220 and the fine material dispenser 222 may be offset in relation to the positioning system of the gantries 210A and 2108. In either case, the use of separate gantries 210A and 210B may reduce the likelihood of interference between an inactive dispenser and a 3D object being built 250 (i.e., a 3D object core or a 3D object shell) by an active dispenser.

For the hybrid 3D printing systems 200A and 200B, various other features are supported. For example, the hybrid 3D printer 100 or the hybrid 3D printing systems 200A and 200B may implement a fine material dispenser 222 that dispenses more colors than the course material dispenser 220. Further, the controller 102 may switch between the coarse material dispenser 220 and the fine material dispenser 222 multiple times while forming layers of the 3D object. Further, the controller 102 may directs a fine 3D printing interface 104 to fill in grooves in the 3D object core when forming the 3D object shell. In such case, the grooves are likened to valleys in the surface of the 3D object core and the operation of the fine 3D printing interface 104 is to apply more material to the valleys than to the peaks in the surface of the 3D object core. For the hybrid 3D printing systems 200A and 200B, a dataset received by the controller 102 defines dimensions for the 3D object. Thus, another feature of the hybrid 3D printing systems 200A and 200B is that the controller 102 determines a size for the 3D object core and for a thickness of the 3D object shell so that a combination of the 3D object core and the 3D object shell is in accordance with the defined dimensions for the 3D object. Alternatively, the 3D object core may correspond to the dimensions for the 3D object defined by the dataset, and the 3D object shell corresponds to a minimal layer of fine material to smooth and/or color the surface of the 3D object core.

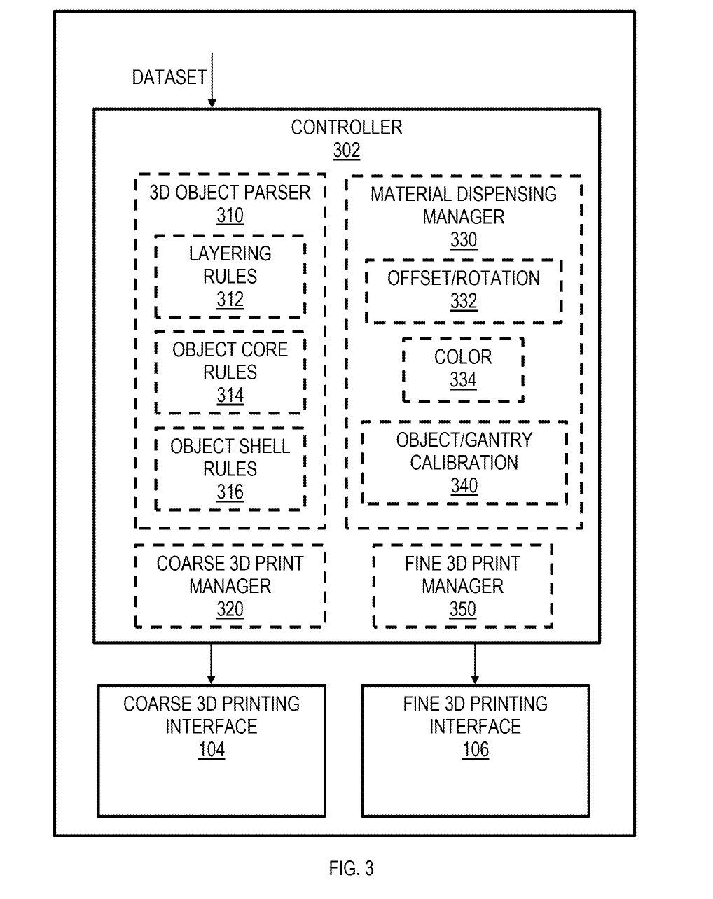

FIG. 3 shows another example of a hybrid 3D printer 300 in accordance with the disclosure. As shown, the hybrid 3D printer 300 comprises a controller 302 in communication with a coarse 3D printing interface 104 and a fine 3D printing interface 106, where the controller 302 supports various functions. In some examples, the controller 302 may correspond to an application-specific integrated circuit (ASIC) or programmable hardware. The controller 302 may perform the same or similar operations as those described for the controller 102. In FIG. 3, the controller 302 comprises a 3D object parser 310, a material dispensing manager 330, a coarse 3D print manager 320, and a fine 3D print manager 350 to perform the various hybrid 3D printing operations described herein.

The 3D object parser 310 extracts information from a received dataset corresponding to a 3D object and applies various rules. For example, the layering rules 312 may comprise a set of rules or parameters that establish how to parse the 3D object based on the capabilities of the coarse 3D printing interface 104, the capabilities of the fine 3D printing interface 106, and the shape of the 3D object. If multiple layers are needed, the layering rules 312 establish the number of coarse material layers, the number of fine material layers, the dimensions of the layers, and when the layers are applied. Meanwhile, the object core rules 314 comprise a set of rules or parameters that establish how to form the 3D object core based on the capabilities of the coarse 3D printing interface 104, the dimensions/shape of the 3D object, and the outcome of applying the layering rules 312 to the 3D object. Meanwhile, the object shell rules 316 comprise a set of rules or parameters that establish how to form the 3D object shell based on the capabilities of the fine 3D printing interface 106, the dimensions/shape of the 3D object, and the outcome of applying the layering rules 312 to the 3D object.

The material dispensing manager 300 manages various control features of the hybrid 3D printer 300. For example, the material dispensing manager 330 may comprise offset/rotation instructions 332 to account for any offset of the course material dispenser 220 and/or the fine material dispenser from a gantry positioning system. The offset/rotation instructions 332 also may provide rotation rules or parameters for any rotation performed (e.g., by a rotation component 212) when activating or deactivating the course material dispenser 220 and/or the fine material dispenser 222. The color instructions 334 extracts color information from the dataset of the 3D object for use by the course 3D printing interface 104 and/or the fine 3D printing interface 106. In some examples, the course 3D printing interface 104 supports dispensing a monochrome course material (e.g., a softened or melted polymer) for the 3D object core, while the fine 3D printing interface 106 supports dispensing a multi-color fine material (e.g., latex ink) for the 3D object shell.

The object/gantry calibration instructions 340 enable a gantry positioning system to be calibrated for an object yet to be built or for an object being built 250. For example, if the orientation of the object being built 250 changes, the object/gantry calibration instructions 340 enables a gantry positioning system to adjust to account for the change in the orientation of the object being built 250.

The coarse 3D print manager 320 prepares data and/or instructions for the coarse 3D printing interface 104 based on information received from the 3D object parser 310 and the material dispensing manager 330. Similarly, fine 3D print manager 350 prepares data the fine 3D printing interface 106 based on information received from the 3D object parser 310 and the material dispensing manager 330.

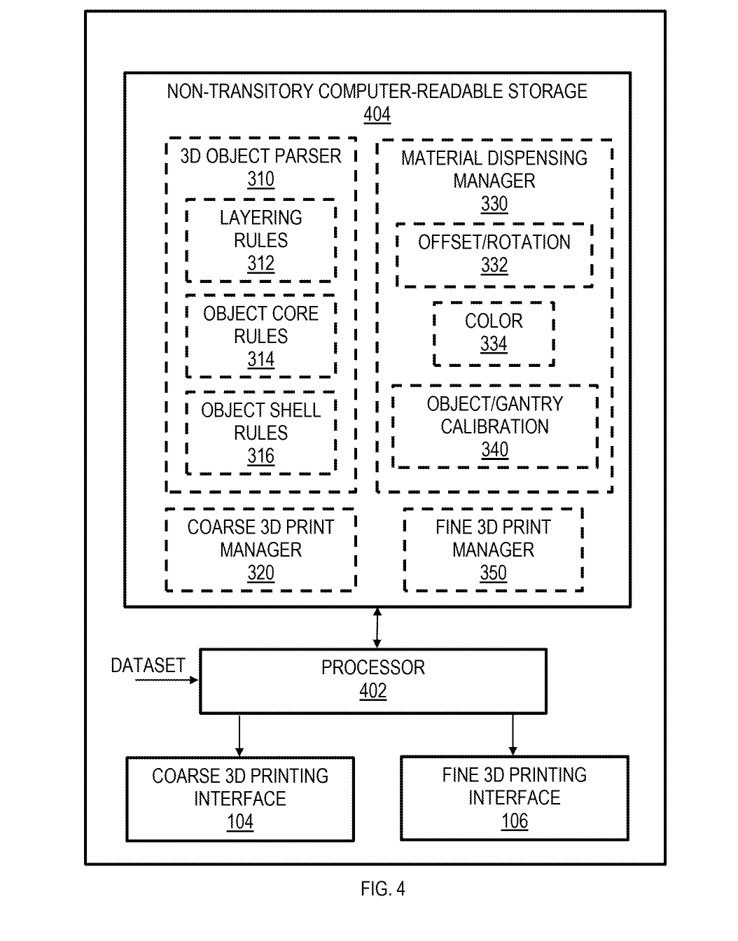

FIG. 4 shows another example of a hybrid 3D printer 400 in accordance with the disclosure. As shown, the hybrid 3D printer 400 comprises a processor 402 coupled to a non-transitory computer-readable storage 404 that stores modules corresponding to the functions of the 3D object parser 310, the material dispensing manager 330, the coarse 3D print manager 320, and the fine 3D print manager 350 described for FIG. 3. In operation, the processor 402 executes the 3D object parser 310, the material dispensing manager 330, the coarse 3D print manager 320, and the fine 3D print manager 350 stored by the non-transitory computer-readable storage 404 and provides corresponding data and/or instructions to the coarse 3D printing interface 104 to form the 3D object core. Similarly, the processor 402 executes the 3D object parser 310, the material dispensing manager 330, the coarse 3D print manager 320, and the fine 3D print manager 350 stored by the non-transitory computer-readable storage 404 and provides corresponding data and/or instructions to the fine 3D printing interface 106 to form the 3D object shell.

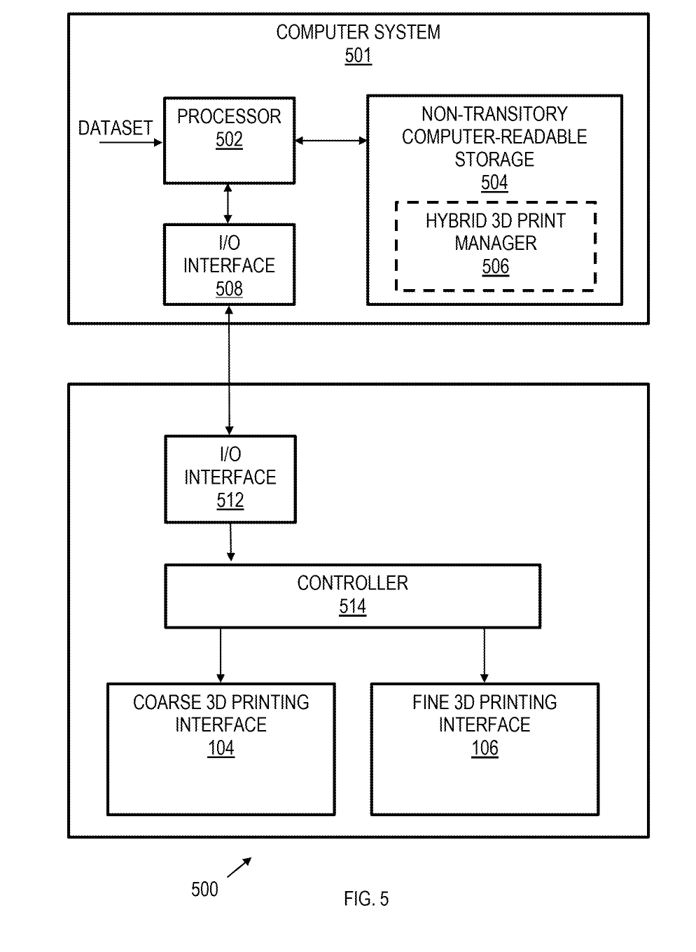

FIG. 5 shows another example of a hybrid 3D printing system 500 in accordance with the disclosure. As shown, the hybrid 3D printing system 500 comprises a computer system 501 in communication with a hybrid 3D printer 510. The computer system 501 comprises with a processor 502 coupled to a non-transitory computer-readable storage 504 that stores a hybrid 3D print manager 506. The processor 502 also couples to an input/output (I/O) interface 508 of the computer system 501. When executed by the processor 502, the hybrid 3D print manager 506 performs the same or similar functions described for the 3D object parser 310, the material dispensing manager 330, the coarse 3D print manager 320, and the fine 3D print manager 350 described for FIG. 3. However, rather than output data and/or instructions directly to the coarse 3D printing interface 104 and/or the fine 3D printing interface 106, the processor 502 transmits data and/or instructions to the I/O interface 508. The computer system 501 may corresponds to a desktop computer, a laptop computer, a tablet computer, a smart phone, or other computing device capable of executing the hybrid 3D print manager 506 and communicating with the hybrid 3D printer.

In operation, the I/O interface 508 of the computer system 501 transmits the data and/or instructions from the processor 502 executing the hybrid 3D print manager 506 to an I/O interface 512 of the hybrid 3D printer 510. The I/O interface 508 of the computer system 501 and the I/O interface 512 of the hybrid 3D printer 510 may communicate via known wired or wireless communication techniques. Further, the I/O interface 508 of the computer system 501 and the I/O interface 512 of the hybrid 3D printer 510 may communicate via known local communication protocols or remote communication protocols. In other words, the computer system 501 may be located near the hybrid 3D printer 510 (adjacent to or in the same room) or may be located remotely from the hybrid 3D printer 510 (i.e., communication occurs via a network).

As shown, the I/O interface 512 couples to a controller 514, which directs received data and/or instructions to the course 3D printing interface 104 and/or the fine 3D printing interface 106. In some examples, the controller 514 may also perform some of the operations needed for 3D printing. For example, the controller 514 may perform the operations described for the course 3D print manager 320 and/or for the fine 3D print manager 330. In such case, the controller 514 may prepare data and/or instructions for the coarse 3D printing interface 104 based on 3D object parser information and/or material dispensing management information received from the computer system 501. Similarly, the controller 514 may prepare data and/or instructions for the fine 3D printing interface 106 based on 3D object parser information and/or material dispensing management information received from the computer system 501.

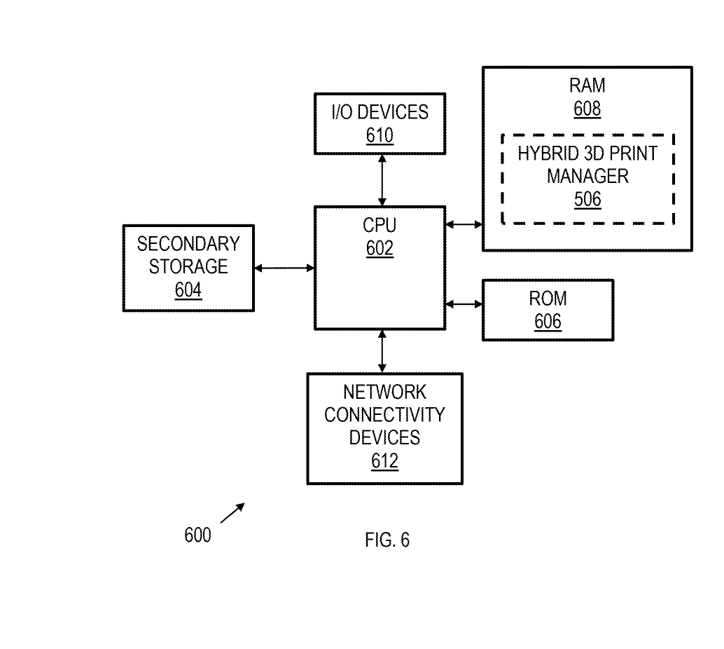

FIG. 6 shows an example of a computer system 600 in accordance with the disclosure. The computer system 600 may perform various operations to support hybrid 3D printing. The computer system 600 may be part of a hybrid 3D printer or may be in communication with a hybrid 3D printer to support hybrid 3D printing operations as described herein.

As shown, the computer system 600 includes a processor 602 (which may be referred to as a central processor unit or CPU) that is in communication with memory devices including secondary storage 604, read only memory (ROM) 606, random access memory (RAM) 608, input/output (I/O) devices 610, and network connectivity devices 612. The processor 602 may be implemented as one or more CPU chips.

It is understood that by programming and/or loading executable instructions onto the computer system 600, at least one of the CPU 602, the RAM 608, and the ROM 606 are changed, transforming the computer system 600 in part into a particular machine or apparatus having the novel functionality taught by the present disclosure. In the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. For example, a design that is still subject to frequent change may be implemented in software, because re-spinning a hardware implementation is more expensive than re-spinning a software design. Meanwhile, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine or apparatus.

The secondary storage 604 is may be comprised of one or more disk drives or tape drives and is used for non-volatile storage of data and as an over-flow data storage device if RAM 608 is not large enough to hold all working data. Secondary storage 604 may be used to store programs which are loaded into RAM 608 when such programs are selected for execution. The ROM 606 is used to store instructions and perhaps data which are read during program execution. ROM 606 is a non-volatile memory device which typically has a small memory capacity relative to the larger memory capacity of secondary storage 604. The RAM 608 is used to store volatile data and perhaps to store instructions. Access to both ROM 606 and RAM 608 is typically faster than to secondary storage 604. The secondary storage 604, the RAM 608, and/or the ROM 606 may be referred to in some contexts as computer readable storage media and/or non-transitory computer readable media.

I/O devices 610 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 612 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 612 may enable the processor 602 to communicate with the Internet or one or more intranets. With such a network connection, it is contemplated that the processor 602 might receive information from the network, or might output information to the network in the course of performing the above-described method steps. Such information, which is often represented as a sequence of instructions to be executed using processor 602, may be received from and outputted to the network, for example, in the form of a computer data signal embodied in a carrier wave.

Such information, which may include data or instructions to be executed using processor 602 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well known to one skilled in the art. The baseband signal and/or signal embedded in the carrier wave may be referred to in some contexts as a transitory signal.

The processor 602 executes instructions, codes, computer programs, scripts which it accesses from hard disk, floppy disk, optical disk (these various disk based systems may all be considered secondary storage 604), ROM 606, RAM 608, or the network connectivity devices 612. While only one processor 602 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 604, for example, hard drives, floppy disks, optical disks, and/or other device, the ROM 606, and/or the RAM 608 may be referred to in some contexts as non-transitory instructions and/or non-transitory information.

In an embodiment, the computer system 600 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 600 to provide the functionality of a number of servers that is not directly bound to the number of computers in the computer system 600. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the hybrid 3D printing control functionality disclosed above may be provided as a computer program product. For example, the RAM 608 may store the hybrid 3D print manager 506 described for FIG. 5 for execution by the processor 602 to perform hybrid 3D printing control functionality as described herein. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 600, at least portions of the contents of the computer program product to the secondary storage 604, to the ROM 606, to the RAM 608, and/or to other non-volatile memory and volatile memory of the computer system 600. The processor 602 may process the executable instructions and/or data structures in part by directly accessing the computer program product, for example by reading from a CD-ROM disk inserted into a disk drive peripheral of the computer system 600. Alternatively, the processor 602 may process the executable instructions and/or data structures by remotely accessing the computer program product, for example by downloading the executable instructions and/or data structures from a remote server through the network connectivity devices 612. The computer program product may comprise instructions that promote the loading and/or copying of data, data structures, files, and/or executable instructions to the secondary storage 604, to the ROM 606, to the RAM 608, and/or to other non-volatile memory and volatile memory of the computer system 600.

In some contexts, the secondary storage 604, the ROM 606, and the RAM 608 may be referred to as a non-transitory computer readable medium or a computer readable storage media. A dynamic RAM embodiment of the RAM 608, likewise, may be referred to as a non-transitory computer readable medium in that while the dynamic RAM receives electrical power and is operated in accordance with its design, for example during a period of time during which the computer 600 is turned on and operational, the dynamic RAM stores information that is written to it. Similarly, the processor 602 may comprise an internal RAM, an internal ROM, a cache memory, and/or other internal non-transitory storage blocks, sections, or components that may be referred to in some contexts as non-transitory computer readable media or computer readable storage media.

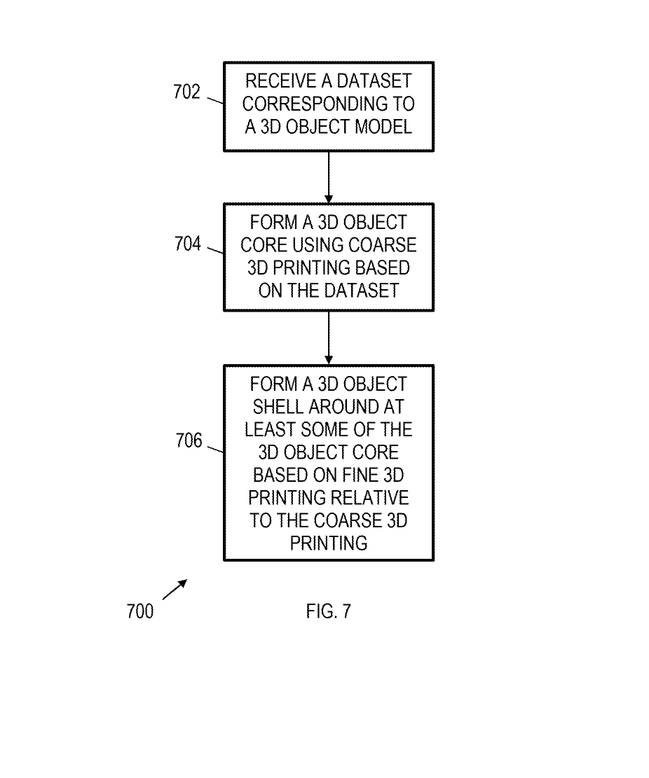

FIG. 7 shows an example of a hybrid 3D printing method 700 in accordance with the disclosure. As shown, the method 700 comprises receiving a dataset corresponding to a 3D object model (block 702). A 3D object core is formed using coarse 3D printing based on the dataset (block 704). Also, a 3D object shell is formed around at least some of the 3D object core based on fine 3D printing relative to the coarse 3D printing (block 706).

In some examples, the method 700 may comprise additional steps. For example, the method 700 may additionally comprise toggling back and forth multiple times between dispensing course material with the coarse 3D printing and dispensing fine material with the fine 3D printing to form the object core and the object shell. Further, the method 700 may comprise accounting for an offset between a course material dispenser and a fine material dispenser when forming the object shell using fine 3D printing. Further, the method 700 may comprise filling in grooves in the 3D object core when forming the 3D object shell. Further, the method 700 may comprise determining a thickness of the 3D object shell so that a combination of the object core and the object shell is in accordance with dimensions for the 3D object defined by the dataset. Further, the method 700 may comprise other 3D printing operations as described herein.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A three-dimensional (3D) printing system, comprising:
a coarse 3D printing interface to form a 3D object core;
a fine 3D printing interface to form a 3D object shell around at least some of the 3D object core; and
a controller to receive a dataset corresponding to a 3D object model and to direct the coarse 3D printing interface to form the 3D object core based on the dataset.

2. The 3D printing system of claim 1, wherein the coarse 3D printing interface comprises a fused deposition modeling (FDM) dispenser and wherein the fine 3D printing interface comprises a thermal inkjet (TIJ) dispenser.

3. The 3D printing system of claim 1, wherein the coarse 3D printing interface comprises a course material dispenser and wherein the fine 3D printing interface comprises a fine material dispenser.

4. The 3D printing system of claim 3, wherein the course material dispenser and the fine material dispenser are mounted to a single gantry in communication with the controller.

5. The 3D printing system of claim 4, further comprising a rotating dispenser comprising both the course material dispenser and the fine material dispenser.

6. The 3D printing system of claim 3, wherein the course material dispenser and the fine material dispenser are mounted to separate gantries in communication with the controller.

7. The 3D printing system of claim 3, wherein the fine 3D printing interface comprises a thermal ink dispenser and with the 3D printing interface forms the 3D object shell based on a predetermined offset between the course material dispenser and the fine material dispenser.

8. The 3D printing system of claim 3, wherein the fine material dispenser dispenses more colors than the course material dispenser.

9. The 3D printing system of claim 3, wherein the controller switches between the coarse material dispenser and the fine material dispenser multiple times while forming layers of the 3D object.

10. The 3D printing system of claim 1, wherein the controller directs the fine 3D printing interface to fill in grooves in the 3D object core when forming the 3D object shell.

11. The 3D printing system of claim 1, wherein the dataset defines dimensions for the 3D object, and wherein the controller determines a size for the 3D object core and a thickness for the 3D object shell so that a combination of the 3D object core and the 3D object shell is in accordance with the defined dimensions for the 3D object.

12. A method for three-dimensional (3D) printing, comprising:
receiving a dataset corresponding to a 3D object model;
forming a 3D object core using coarse 3D printing based on the dataset;
and forming a 3D object shell around at least some of the 3D object core based on fine 3D printing relative to the coarse 3D printing.

13. The method of claim 12, further comprising toggling back and forth multiple times between dispensing course material with the coarse 3D printing and dispensing fine material with the fine 3D printing to form the 3D object core and the 3D object shell.

14. The method of claim 12, further comprising at least one of filling in grooves in the 3D object core when forming the 3D object shell and determining a thickness of the 3D object shell so that a combination of the 3D object core and the 3D object shell is in accordance with dimensions for the 3D object defined by the dataset.

15. A three-dimensional (3D) printer, comprising:
a fused deposition modeling (FDM) dispenser;
a thermal inkjet (TIJ) dispenser; and
a controller to receive a dataset corresponding to a 3D object model and to direct the FDM dispenser to form a 3D object core based on the dataset and to direct the TIJ dispenser to form a 3D object shell around at least some of the 3D object core.
